(19) United States
(12) Patent Application Publication
(10) Pub. No.: US 2022/0334285 A1
(43) Pub. Date: Oct. 20, 2022

(54) QUALITY ASSURANCE SYSTEM FOR BURIED ASSET DETECTION DATA

(71) Applicant: Alan Haddy, Naples, FL (US)

(72) Inventor: Alan Haddy, Naples, FL (US)

(21) Appl. No.: 17/234,232

(22) Filed: Apr. 19, 2021

(51) Int. Cl. G01V 3/08; G06F 16/215

(52) U.S. Cl. CPC G01V 3/08; G06F 16/215

(57) ABSTRACT

A method and system for ensuring quality of buried asset detection data over a communications network includes a server for receiving buried asset detection data from an electromagnetic locator device (ELD), evaluating a quality of the buried asset detection data and responsive to determining that the quality of the buried asset detection data meets a predefined threshold, transmitting an approval signal to the ELD. Responsive to determining that the quality of the buried asset detection data does not meets the predefined threshold, transmitting a rejection signal to the ELD and closing access for receiving buried asset detection data from the ELD for other sites. The ELD for collecting buried asset detection data at a site, transmitting the buried asset detection data to the server, and receiving signals from the server.

### CROSS-REFERENCE TO RELATED APPLICATIONS

Not Applicable.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### TECHNICAL FIELD

The technical field relates generally to the detection and identification of buried assets (i.e., underground utility lines) and, more specifically, to systems for ensuring the quality of the data gathered during buried asset detection procedures.

### BACKGROUND

Utility lines, such as lines for telephones, electricity distribution, natural gas, cable television, fiber optics, Internet, traffic lights, streetlights, storm drains, water mains, and wastewater pipes, are often located underground. Said utility lines described above are referred to as “buried assets” herein. Consequently, before excavation occurs in an area, especially an urban area, an excavator is typically required to clear excavation activities with the proper authorities and service providers. The clearance procedure usually requires that the excavator contact a central authority (such as “One Call”, “811” and “Call Before You Dig,” which are well known in the art) which, in turn, sends a notification to the appropriate utility companies. Subsequently, each utility company must perform a buried asset detection procedure, which includes having a field technician visit the proposed excavation site, detect the relevant buried assets and physically marking the position of the buried asset using temporary paint or flags.

Usually, a field technician visiting a proposed excavation site utilizes a portable electronic device known as a pipe or cable locator, an electromagnetic locate device (“ELD”), an electromagnetic locator, a buried asset locate device, or a buried asset locator (collectively referred to herein as an “ELD”). Said ELDs are commercial, off-the-shelf, devices employed to detect and identify the position of buried assets. ELDs are usually used in conjunction with a transmitter, so as to create a field that can be detected by the ELD. This is typically achieved by connecting the transmitter to a suitable connection point (i.e., pedestal, hydrant, manhole, removable cover, lid, junction box or other access point) of the buried asset, wherein the transmitter sends a signal of a specific frequency onto the buried asset. Subsequently, the ELD is “tuned” to the specific frequency in order to locate the resulting electromagnetic signal radiating from the buried asset, thus enabling the position and route of the buried asset to be marked with paint or flags above surface. Best practice standards require the operator perform very specific and consistent physical motions with the ELD such as sweeping, rotating, and lifting, all while the ELD must be orientated correctly to the plane of the buried asset to ensure correct geometric alignment with the radiated electromagnetic field. The process of detecting and marking out a buried asset using an ELD is referred to herein as a buried asset locate procedure, buried asset location procedure, or a buried asset detection procedure.

The aforementioned buried asset location procedure, however, takes time and training to master. There are a variety of techniques that the field technician must learn in order to perform buried asset location procedures in a way that meets best practice standards. When a field technician does not utilize proper techniques during buried asset location procedures, the quality of the data gathered during said buried asset detection procedures suffers. Said data gathered during said buried asset detection procedures (otherwise known as buried asset detection data) includes, among other things, global coordinates for the location of buried assets. Low quality buried asset detection data which do not accurately reflect the location of a buried asset results in errors such as incorrect paint markings and flags on the ground. When excavators are not provided with accurate and precise buried asset detection data, they can inadvertently damage a buried asset during excavation. Incursions into buried assets can be expensive and time consuming to fix or replace.

There are conventional solutions for evaluating the quality of buried asset detection data. Said solutions entail the upload of said data after the buried asset detection procedure is complete and the evaluation of said data at a later time. But by the time the quality of the data has been determined, the field technician may be in a different location, which would require the field technician to return the area to redo the buried asset detection procedure. Said travelling back and forth can be costly and time consuming. This problem is compounded by the fact that field technicians have a high workload and must complete a set number of buried asset detection procedures each day. As a result, technicians must be able to complete buried asset detection procedures quickly and accurately and then immediately move on to the next procedure. Consequently, the conventional solutions for evaluating the quality of buried asset detection data are of limited utility.

Therefore, a need exists for improvements over the prior art, and more particularly for more efficient methods and systems for ensuring the quality of the data gathered during buried asset detection procedures.

### SUMMARY

A system and method for ensuring quality of buried asset detection data over a communications network is provided. This Summary is provided to introduce a selection of disclosed concepts in a simplified form that are further described below in the Detailed Description including the drawings provided. This Summary is not intended to identify key features or essential features of the claimed subject matter. Nor is this Summary intended to be used to limit the claimed subject matter's scope.

In one embodiment, the system for ensuring quality of buried asset detection data over a communications network includes a server communicably coupled with a communications network, the server including a processor configured for: a) receiving buried asset detection data from an electromagnetic locator device (ELD) over the communications network; b) evaluating a quality of the buried asset detection data; c) responsive to determining that the quality of the buried asset detection data meets a predefined threshold, transmitting an approval signal over the communications network to the ELD, wherein the approval signal indicates the quality of the buried asset detection data meets the predefined threshold, and opening access for receiving additional buried asset detection data from the ELD, d) responsive to determining that the quality of the buried asset detection data does not meet the predefined threshold, transmitting a rejection signal over the communications network to the ELD, wherein the rejection signal indicates the quality of the buried asset detection data does not meet the predefined threshold, and closing access for receiving buried asset detection data from the ELD for other sites. The system further includes the ELD communicably coupled with the communications network, the ELD including a processor configured for: a) collecting a first set of buried asset detection data at a site using the locate functionality; b) transmitting the first set of buried asset detection data to the server over the communications network; c) wherein if the first buried asset detection data meets the predefined threshold, receiving from the server, over the communications network, the approval signal; d) wherein if the first buried asset detection data does not the predefined threshold, receiving from the server, over the communications network, the rejection signal.

### BRIEF DESCRIPTION OF THE DRAWINGS

The accompanying drawings, which are incorporated in and constitute a part of this disclosure, illustrate various example embodiments. In the drawings:

FIG. 1 is a diagram of an operating environment that supports a quality assurance system for buried asset detection data, according to an example embodiment;

FIG. 2 is a diagram showing data flow for a quality assurance system for buried asset detection data, according to an example embodiment;

FIG. 3 is a flow chart showing the control flow of a quality assurance system for buried asset detection data, according to an example embodiment;

FIG. 4 is an illustration of a graphical user interface in an ELD that displays data associated with a buried asset location procedure;

FIG. 5A is an illustration showing movement of the ELD in various degrees of freedom, according to an example embodiment;

FIG. 5B is an illustration of an alternative graphical user interface in an ELD that displays data associated with a buried asset location procedure; and,

FIG. 6 is a block diagram of a system including a computing device, according to an example embodiment.

### DETAILED DESCRIPTION

The following detailed description refers to the accompanying drawings. Wherever possible, the same reference numbers are used in the drawings and the following description to refer to the same or similar elements. While embodiments may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the claimed subject matter. Instead, the proper scope of the claimed subject matter is defined by the appended claims.

The claimed subject matter improves over the prior art by providing a quality assurance system that results in field technicians increasing the quality of their buried asset locate procedures and, by extension, the resulting buried asset detection data. The claimed subject matter reduces or eliminates the requirement that a field technician must return to a site to redo a procedure, because the system provides a quality reading immediately while the field technician is still on-site, thereby allowing the technician to redo the procedure instantly. The claimed subject matter also reduces or eliminates poor quality buried asset detection data, as field technicians are notified of the quality of their data while still onsite, which allow the technician to remedy the situation by conducting a better-quality buried asset detection procedure. Also, the claimed quality assurance system is advantageous because it results in accurate and precise buried asset detection data, thereby reducing or eliminating inadvertent damage to buried assets during excavation, including incursions, which can be expensive, and time consuming to fix or replace.

The claimed subject matter also improves over the prior art by providing a more efficient, automated, and precise way of measuring the performance of a field technician during a buried asset locate procedure for quality control and quality assurance purposes and provide quick feedback on said quality to the technician while he is still on-site. Additionally, the example embodiments accommodate the high workload of field technicians and aids the technician in completing a high number of buried asset detection procedures each day. This is advantageous for smaller businesses.

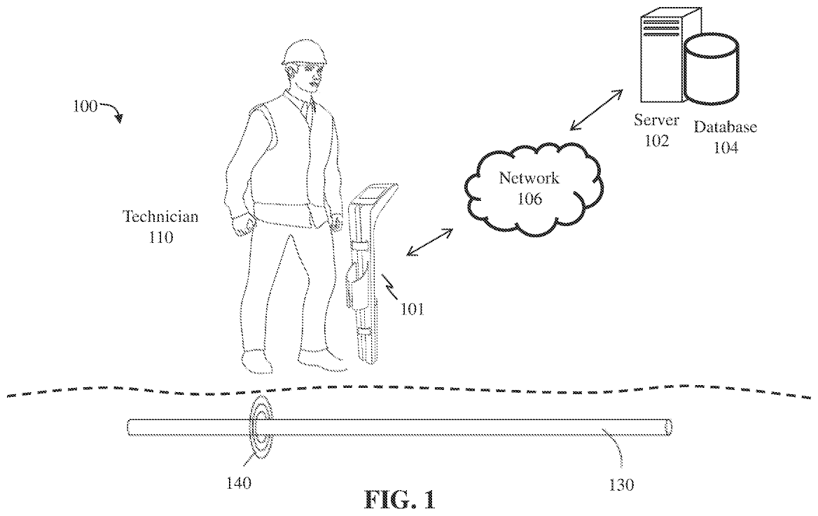

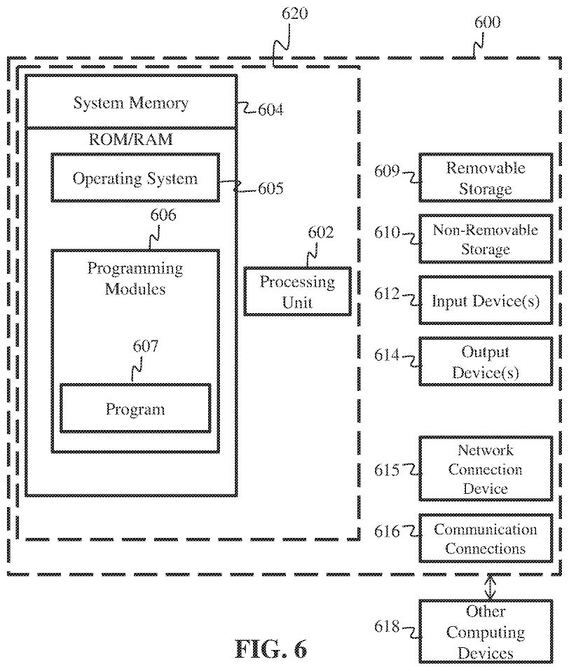

FIG. 1 is a diagram of an operating environment that supports a quality assurance system 100 for buried asset detection data, according to an example embodiment. FIG. 1 shows an electromagnetic locator device (ELD) 101 operated by a field technician 110, wherein the ELD includes one or more sensors that detect and measure radio frequency and/or electromagnetic signals 140 emanating from a buried asset 130. In one embodiment, ELD 101 includes all of the functions of a conventional ELD, which is well known in the art. The ELD 101 and the server 102 may be communicatively coupled with a communications network 106, and the ELD 101 may communicate with server 102 via the communications network 106. ELD 101 may comprise a mobile computing device connected wirelessly to the communications network 106. Communications network 106 may be a packet switched network, such as the Internet, or any local area network, wide area network, enterprise private network, cellular network, phone network, mobile communications network, radio network, or any combination of the above. As such, ELD 101 and server 102 may each comprise a computing device 600, described below in greater detail with respect to FIG. 6.

In one embodiment, the ELD 101 is a handheld cable locator well known in the art, wherein the cable locator includes a series of electromagnetic antennas that take electromagnetic readings emanating from a buried asset, and wherein the cable locator processes said readings, and then displays information about said readings on a display for the technician to view. In another embodiment, the ELD 101 also calculates the current position, or local position, and orientation of the ELD 101 in the local area or the site.

Computing system 102 includes a software engine that delivers applications, data, program code and other information to networked devices, such as ELD 101. The software engine of computing system 102 may perform other processes such as transferring multimedia data in a stream of packets that are interpreted and rendered by a software application as the packets arrive. FIG. 1 further shows that computing system 102 includes a database or repository 104, which may be a relational database comprising a Structured Query Language (SQL) database stored in a SQL server. Computing device 101 may also include its own database, either locally or via the cloud. The database 104 may receive, store, and serve buried asset data, buried asset data points, buried asset detection data, quality data, buried asset locate performance data, as well as related information, which may be used by computing device 101 and others.

Computing system 102 and ELD 101 may each include program logic comprising computer source code, scripting language code or interpreted language code that perform various functions of the disclosed embodiments. In one embodiment, the aforementioned program logic may comprise program module 607 in FIG. 6. It should be noted that although FIG. 1 shows only one computing system 102 and one ELD 101, the system of the disclosed embodiments supports any number of servers, ELDs and mobile computing devices connected via a network. Also note that although computing system 102 is shown as a single and independent entity, in one embodiment, computing system 102 and its functionality can be realized in a centralized fashion in one computer system or in a distributed fashion wherein different elements are spread across several interconnected computer systems.

In one embodiment, the computing system 102 includes the functionality of an 811 ticket system. Said system includes a ticket system, also known as an issue tracking system, which is a computer software platform that manages and maintains lists of work order requests (i.e., tickets) for conducting buried asset detection procedures at sites where excavations are to take place. Tickets are completed in sequence by a technician 110. For example, a technician may receive two tickets, wherein each ticket represents a buried asset detection procedure that must be completed at a unique site. The technician may open the first ticket, complete the buried asset detection procedure at the first site, and then close the first ticket. Subsequent to closing the first ticket, the technician opens the second ticket, completes the buried asset detection procedure at the second site, and then closes the second ticket.

System 100 may be used when device 101 engages in buried asset detection activities that comprise reading, generating, and storing buried asset data and related information. Various types of data may be stored in the database 104 and devices 101, 102 with relation to buried asset detection activities. For example, the database 104 (or devices 102 and ELD 101) may store one or more records for each buried asset, and each record may include one or more buried asset data points. A buried asset data point may include a current time, a textual map address, and location data or position data, such as latitude and longitude coordinates, geographical coordinates, an altitude coordinate, or the like. A buried asset data point may also include depth measurement data, electromagnetic signal measurement data (such as electrical current measurement data, resistance measurement data, impedance measurement data, electrical signal magnitude measurement data, electrical signal frequency measurement data, electrical signal voltage measurement data, etc.), direction data and orientation data. Each record may include data for one buried asset data point.

Database 104 may also store buried asset detection data comprising at least depth data, depth measurement data, electromagnetic signal measurement data, direction data, orientation data and any data associated with a buried asset data point. Buried asset detection data may further comprise motion data of the ELD, electromagnetic data from the ELD, a mode of the ELD, position data of the ELD, and any other data associated with quality, as described more fully below.

Database 104 may also include a plurality of locate performance records. A locate performance record comprises real time sensor and data fusion derived from multiple sensors and inputs that enable inertial motion capture, electromagnetic locate signal analysis, position data, and mode configuration data, among other things. Database 104 may include one or more a lookup tables that define a correspondence between each one of a plurality of component values of a performance record and one of a plurality of performance measurements of a buried asset location procedure performed by a field technician. Said lookup tables may represent industry standards for buried asset location procedure and technique. I.e., said lookup tables may represent a benchmark against which a locate technician's performance can be compared. A performance measurement may be a graduating or continuous numerical scale, such as from 1 to 10, wherein 1 is considered low performance and 10 is considered excellent performance. A performance measurement may also be a set of words, for example, wherein the word BAD is considered low performance and the word GOOD is considered excellent performance. Note that in this description, any of the data described as stored in database 104 may also be stored in device 101.

The ELD 101 may also include a switch which may be a hardware switch (also described below), which is an electrical component that can disconnect or connect the conducting path in an electrical circuit, diverting it from one conductor to another. The switch may be an electromechanical device consisting of one or more sets of movable electrical contacts connected to external circuits. When a pair of contacts is touching current can pass between them, while when the contacts are separated no current can flow. The hardware switch may switch or divert the conducting path of the electromagnetic antennas of the ELD 101. Alternatively, the switch may be software enabled, in the sense that the switch may be implemented in software, such that software may control the conducting path of the electromagnetic antennas of the ELD 101. In this alternative, the software enabled switch may be activated or deactivated by the processor on the ELD 101.

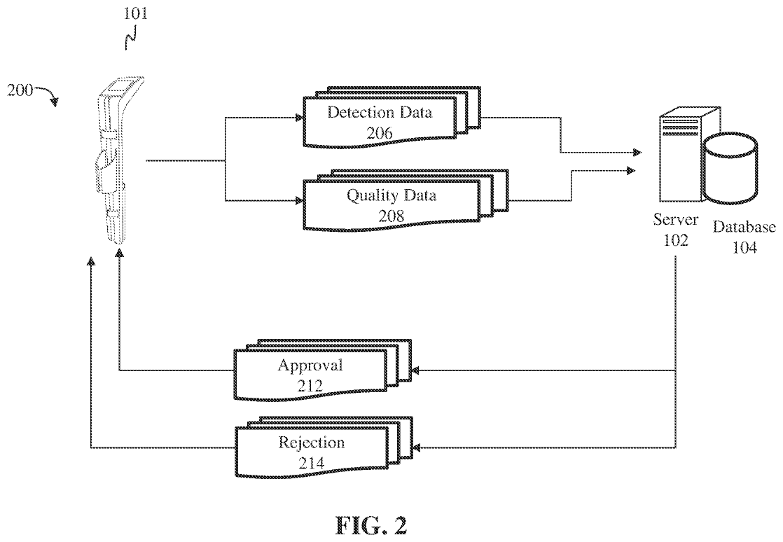

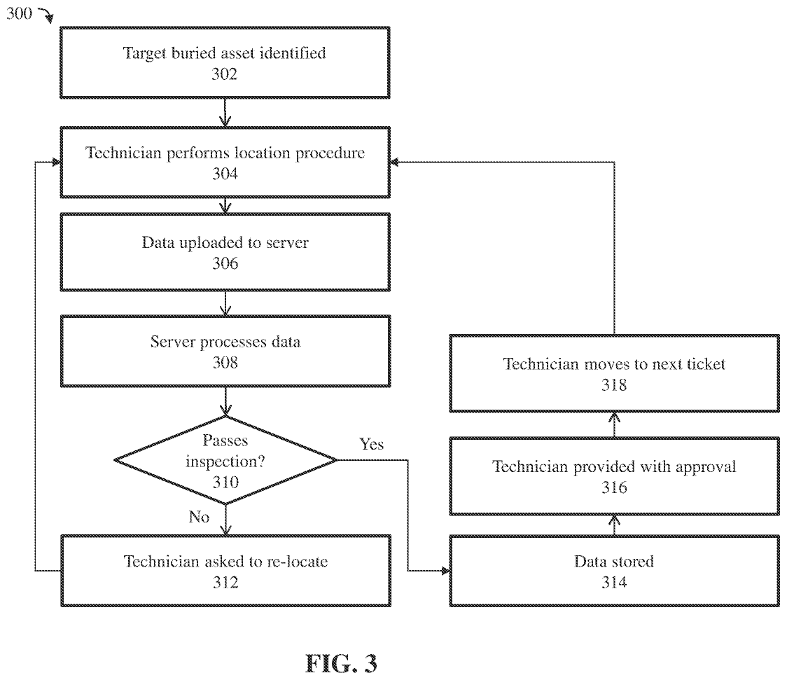

The method and system of the claimed embodiments will now be described with reference to FIG. 3, which is a flow chart showing the control flow of the quality assurance system 100 for buried asset detection data, and FIG. 2, which is a diagram showing the data flow of the quality assurance system 100. Process 300 describes the steps that begin to occur when the locate technician 110 starts the process detecting and identifying a buried asset 130 located within an area or a site. The process 300 is described with reference to FIG. 2, which shows the general data flow 200 of the process 300. Prior to the beginning of the process 300, it is assumed that stored in database 104 or device 101 is one or more lookup tables, as described above.

Process 300 starts in earnest with step 302, wherein the technician identifies a general location (or site) of the target buried asset 130, travels to said site, and opens a ticket in the ticket system for the buried asset location procedure he will conduct in step 304. In step 304, ELD 101 calculates and stores its orientation and position data. The ELD 101 also calculates and stores the strength, magnitude, and frequency of the electromagnetic field 140 emanating from the target buried asset 130.

In step 304, the technician 110 performs a buried asset location procedure using his ELD 101. The ELD 101 generates buried asset detection data and/or buried asset data points 206. Upon generating the buried asset data points, the technician may place physical or virtual markings on the ground corresponding to each point, such as a flag, a paint mark, or a combination of the two. In step 304, the ELD 101 may also produce quality data 208 such as motion data of the ELD, electromagnetic data from the ELD, a mode of the ELD, position data of the ELD, and any other data associated with quality, as described more fully below. The quality data 208 may also include data related to the peak or null readings or points read by the ELD 101, as well as the mode of operation of the ELD 101.

Data 206, 208 may include the following raw data produced by the ELD as a result of performance of the buried asset location procedure by the field technician 110: 1) motion data from an accelerometer and a gyroscope in the ELD, and wherein said motion data includes motion in three dimensions, and wherein said motion data is produced as a result of movement of the ELD by the field technician during performance of the buried asset location procedure (may also be garnered from rotation or tilt sensor), 2) electromagnetic data from one or more electromagnetic sensors in the ELD, wherein said electromagnetic data includes current and depth measurements, as well as device gain and full scale deflection data, and wherein said electromagnetic data is produced as a result of movement of the ELD by the field technician during performance of the buried asset location procedure, 3) a mode of the ELD, wherein the mode includes a frequency mode of the ELD, and wherein the mode is set by the field technician during performance of the buried asset location procedure, and 4) position data of the ELD in area or site.

Motion data may include the detection and logging of various vectors in all degrees of motion, velocity, and acceleration of the ELD. Electromagnetic data may include electrical current measurement data, resistance measurement data, impedance measurement data, electrical signal magnitude measurement data, electrical signal frequency measurement data, electrical signal voltage measurement data, etc. The electromagnetic data produced by the ELD may be displayed in the ELD, wherein motion data (leading up to the logging of the electromagnetic data) from the accelerometer and gyroscope in the ELD is stored, such that said motion data may be evaluated to determine proper performance and procedure of the buried asset location procedure leading up to the logging of the electromagnetic data.

A mode of the ELD may include any one of a variety of modes (that are well-known in the art) in which a locator device may be placed. With regard to mode of the ELD, each ELD has various modes that the field technician selects depending on type of utility, type of environment, etc. These device mode selections include frequency selections to match transmitter selection, peak signal mode, null signal mode, peak and null signal modes simultaneously, line versus sonde/probe mode. Said device mode selections may define a locate device operating mode. Each ELD may also collect electromagnetic (EM) signal response data, which indicates how the locator device is responding to the electromagnetic signals (140) it is detecting and processing, as well as signal strength, signal direction (left right of target), system gain control, phase (direction) of signal, measured depth, measured current, etc. The raw data collected above is then used at a later point to generate performance measurements that represent the technician's performance during said buried asset location procedure, according to industry standards.

In step 306, the ELD 101 may transmit the data 206, 208 to the serer 102 via network 106. The system 102 receives the data 206, 208 and creates records in the database 104 to hold said data. Also, in step 306, the ELD 101 may automatically (upon the completion of the transmission of step 306) activate the switch to disable the locate functionality on the ELD. The locate functionality of the ELD is defined as the functionality of the ELD that allows the device to detect and measure radio frequency and/or electromagnetic signals 140 emanating from a buried asset 130. Said locate functionality may remain disabled until a predefined signal is received from the server 102.

In step 308, the server 102 processes the data received in step 306 above and determines whether said data meets a predefined threshold for quality, i.e., whether the performance of the technician 110 meets best practice quality standards, as defined more fully below. In this step, the server 102 calculates sub-metrics based on the raw data collected above. In this step, the server calculates the following raw sub-metrics based on the data collected above, and uses said sub-metrics as the component values of a first quantity vector:
a) an alignment of acceleration of the ELD with gravity, calculated as

$$mean ( \frac{a \cdot g}{‖ a ‖ ‖ g ‖} ) ,$$

b) magnitude of non-gravity acceleration of the ELD, calculated as rms (∥a∥−∥g∥),
c) rotation of the ELD about its x-axis, calculated as rms (ωₓ),
d) rotation of the ELD about its y-axis, calculated as rms (ω_{y}),
e) rotation of the ELD about its z-axis, calculated as rms (ω_{y}).

wherein a may be a vector that represents acceleration, g may be a vector that represents gravity, rms stands for root mean squared and mean stands for a statistical mean.

Next, the server 102 calculates component values of a first exam vector based on the quantity vector, the first exam vector composed of the following components values:
a) a score based on whether the ELD is aligned with gravity, calculated based on

$$mean ( \frac{a \cdot g}{‖ a ‖ ‖ g ‖} ) ,$$

b) a score based on magnitude of motion of the ELD, calculated based on rms (∥a∥−∥g∥),
c) a score based on magnitude of rotation of the ELD about x-axis, calculated based on rms (ωₓ),
d) a score based on magnitude of rotation of the ELD about y-axis, calculated based on rms (ω_{y}),
e) a score based on magnitude of rotation of the ELD about z-axis, calculated based on rms (ω_{z}),
f) a score based on whether rotation of the ELD about the z-axis is dominant calculated based on rms (ω_{y}), rms (ωₓ) and rms (ω_{y}), wherein ω_{y} represents rotation about the y axis, ω_{z} represents rotation about the z axis and ωₓ represents rotation about the x axis.

Each may be rotation vectors, and each may further represent an array of data representing rotation about a specific axis. In one embodiment, a score may be a numerical value, such as the numbers 0, 1 or 2. In another embodiment, a score is based on whether the resulting value is within certain ranges. For example, if rms (ωₓ) is calculated to be greater than 50 units per second, then a score of 2 is applied, if rms (ωₓ) is calculated to be between 18 and 50 units per second, then a score of 1 is applied, and if rms (ωₓ) is calculated to be less than 18 units per second, then a score of 0 is applied. This paradigm may be applied to all factors a) through f) above.

Then, server 102 accesses the lookup table, and reads a performance measurement that corresponds with each one of the plurality of component values of the first exam record, so as to read a plurality of performance measurements. The result of this step is that a plurality of performance measurements is read and stored. Alternatively, server 102 accesses the lookup table, and reads a performance measurement that corresponds with each one of said plurality of component values of the performance record of the field technician 110, so as to read a plurality of performance measurements.

In step 310, server 102 determines if one or more of said plurality of performance measurements are at or above a predefined quality threshold (according to said industry standards embedded in the lookup table), and if so, the control flows to step 314. If one or more of said plurality of performance measurements are below the predefined quality threshold, then control flows to step 312. In step 312, the server 102 may transmit a rejection signal or message 214 to the technician via ELD 101, wherein the ELD may display (such as on a display) the plurality of performance measurements, and wherein the message may indicate that the just-completed buried asset locate procedure was below the quality threshold, and that the field technician must (is prompted to) redo the procedure before he can proceed with additional procedures at other sites. It should be noted that the predefined quality threshold indicates whether the performance of the technician 110 meets best practice quality standards, as defined more fully above. Further in step 312, the current ticket is not closed (it is left open), thereby prohibiting the technician from moving on to the next ticket and therefore the next buried asset location procedure.

Also in step 312, the server 102 may close access to the server 102 for receiving buried asset detection data from the ELD for other sites. I.e., the server 102 may prohibit accepting buried asset detection data from the ELD (via network 106) for other sites until the just-completed buried asset locate procedure is redone correctly, namely, to the required quality standards. Also, the locate functionality of the ELD 101 may remain disabled until a predefined signal is received from the server 102.

In step 314, the data processed by the server 102 is stored and the current ticket may be closed, thereby allowing the technician to move to the next ticket. In step 316 the server 102 may transmit a signal or message 212 to the technician via ELD 101, wherein the ELD may display (such as on a display) the plurality of performance measurements, and wherein the message may indicate that the just-completed buried asset locate procedure meets the quality threshold, and that the field technician may proceed with additional procedures at additional sites. Also in step 314, the server 102 may open access to the server 102 for receiving buried asset detection data from the ELD for other sites. I.e., the server 102 may continue or start accepting buried asset detection data from the ELD (via network 106) for other sites since the just-completed buried asset locate procedure met the required quality standards.

In optional step 316, the server 102 may transmit the signal 212 over the communications network 106 to the ELD, wherein the signal is configured to enable locate functionality on the ELD, wherein said signal is not transmitted if the quality of the buried asset detection data does not meet the predefined threshold. Upon reception of said signal by the ELD 101, the ELD 101 may automatically activate the switch to enable the locate functionality on the ELD. In step 318, the technician 110 moves on to conduct additional buried asset detection procedures at additional or different sites.

Note that in the event that a particular set of buried asset detection data does not pass quality standards in step 310, and the technician is prompted to redo the procedure in step 312, the current ticket is not closed, and the server 102 may close access to the server 102 for receiving buried asset detection data from the ELD for other sites. In this case, control flows to step 304 wherein the technician may redo the buried asset detection procedure at the current site. Once the technician uploads the new buried asset detection data from the current site in step 306, and the server processes said new buried asset detection data in step 308, it may be determined that said new buried asset detection data passes quality standards in step 310. In this case, control flows to step 314 wherein the current ticket is closed, and server 102 may start accepting buried asset detection data from the ELD (via network 106) for other sites since the just-completed buried asset locate procedure met the required quality standards. Subsequently, control flows to steps 316 and 318, and back to step 304 for additional buried asset detection procedures at additional or different sites.

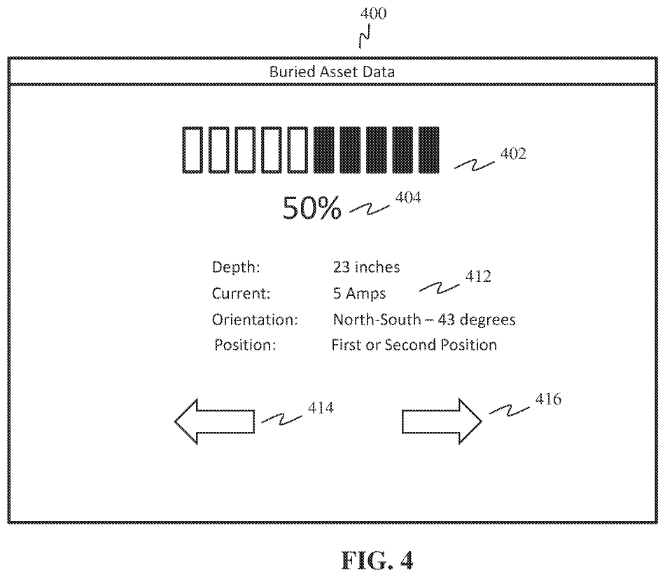

FIG. 4 is an illustration of a graphical user interface 400 in an ELD that displays data associated with a buried asset location procedure, according to an example embodiment. The graphical user interface 400 may apply to the ELD 101. The interface 400 may display buried asset data 412. Recall that buried asset data may include depth, position, electrical signal measurement (such as current, resistance, impedance, magnitude, frequency, voltage, etc.), direction and orientation.

Interface 400 may also include a graphic 402 that indicates the signal strength of the buried asset being detected (such as a meter reading comprising ten bars), and a numerical indicator 404 that indicates the signal strength of the buried asset being detected. In one embodiment, the ELD receives human readable buried asset data and based on the data received, the ELD calculates the appropriate graphic 402 or numerical indicator 404 to display in interface 400. For example, if the ELD receives human readable buried asset data indicating 50% signal strength, the ELD calculates the appropriate graphic 402 to display in interface 400 is five out of ten bars, which graphically indicates 50%. The interface 400 can also include the position the ELD is in so that the technician can confirm that the correct algorithm, process, software, filter etc. is applied to the data received by the ELD.

Lastly, the interface 400 may also include left and right arrows 414, 416, which points the technician in the direction of the location of the buried asset being detected. Left and right arrows 414, 416, may additionally indicate to the technician the direction in which the ELD should be moved in order to read increased signal strength from of the buried asset being detected.

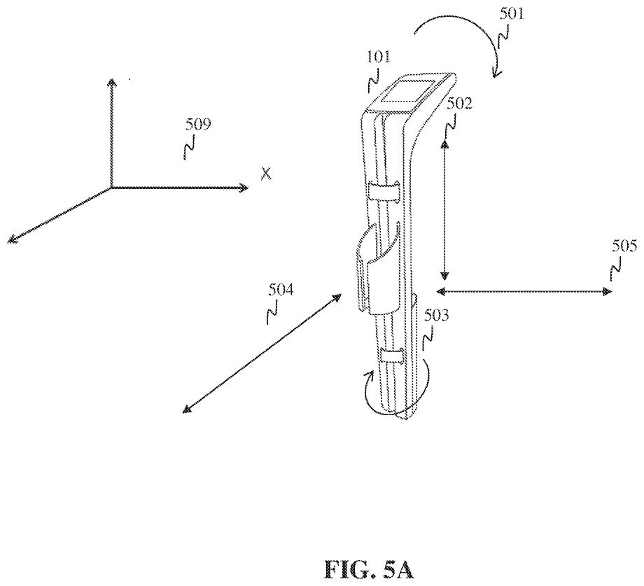

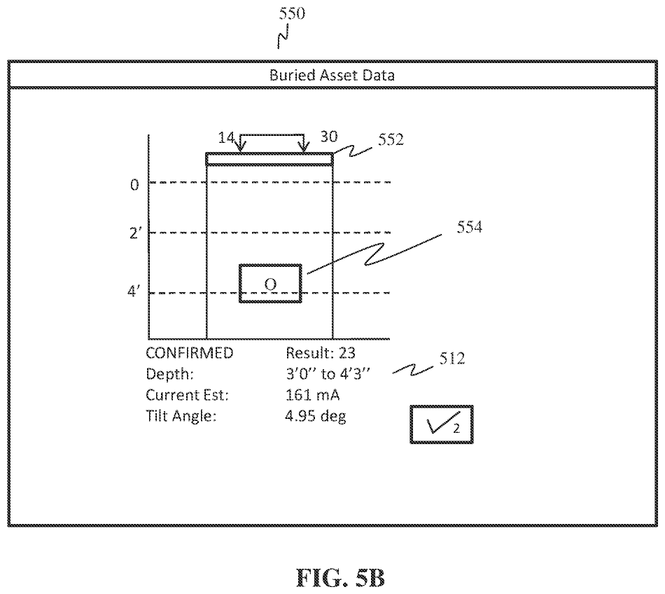

FIG. 5A is an illustration showing movement of the ELD 101 in various degrees of freedom, according to an example embodiment. See the three-dimensional axes 509. Arrow 503 show rotation of the ELD 101 about the z-axis. Arrow 502 shows up and down movement of the ELD 101 along the z-axis. Arrow 504 shows movement of the ELD forward or backwards along the y-axis. Arrow 505 shows movement of the ELD to the sides along the x-axis. Arrow 501 shows tilting of the ELD.

FIG. 5B is an illustration of an alternative graphical user interface 550 in an ELD that displays data associated with the detection of buried asset data, according to an example embodiment. The graphical user interface 550 may apply to the ELD 101. The interface 550 may display buried asset data 512. The interface 550 also shows a graphic 552 that indicates the position of a horizontally oriented ELD on the ground. Under the graphic 552 is a numbered graph that corresponds to the ground and the depth of said ground. The interface 550 also shows a graphic 554 that indicates the position of a buried asset under the ground.

FIG. 6 is a block diagram of a system including an example computing device 600 and other computing devices. Consistent with the embodiments described herein, the aforementioned actions performed by devices 102, 101 may be implemented in a computing device, such as the computing device 600 of FIG. 6. Any suitable combination of hardware, software, or firmware may be used to implement the computing device 600. The aforementioned system, device, and processors are examples and other systems, devices, and processors may comprise the aforementioned computing device. Furthermore, computing device 600 may comprise an operating environment for system 100 and process 300, as described above. Process 300 may operate in other environments and are not limited to computing device 600.

With reference to FIG. 6, a system consistent with an embodiment may include a plurality of computing devices, such as computing device 600. In a basic configuration, computing device 600 may include at least one processing unit 602 and a system memory 604. Depending on the configuration and type of computing device, system memory 604 may comprise, but is not limited to, volatile (e.g., random access memory (RAM)), non-volatile (e.g., read-only memory (ROM)), flash memory, or any combination or memory. System memory 604 may include operating system 605, and one or more programming modules 606. Operating system 605, for example, may be suitable for controlling computing device 600's operation. In one embodiment, programming modules 606 may include, for example, a program module 607 for executing the actions of devices 102, 101. Furthermore, embodiments may be practiced in conjunction with a graphics library, other operating systems, or any other application program and is not limited to any particular application or system. This basic configuration is illustrated in FIG. 6 by those components within a dashed line 620.

Computing device 600 may have additional features or functionality. For example, computing device 600 may also include additional data storage devices (removable and/or non-removable) such as, for example, magnetic disks, optical disks, or tape. Such additional storage is illustrated in FIG. 6 by a removable storage 609 and a non-removable storage 610. Computer storage media may include volatile and nonvolatile, removable, and non-removable media implemented in any method or technology for storage of information, such as computer readable instructions, data structures, program modules, or other data. System memory 604, removable storage 609, and non-removable storage 610 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information, and which can be accessed by computing device 600. Any such computer storage media may be part of device 600. Computing device 600 may also have input device(s) 612 such as a keyboard, a mouse, a pen, a sound input device, a camera, a touch input device, etc. Output device(s) 614 such as a display, speakers, a printer, etc. may also be included. Computing device 600 may also include a vibration device capable of initiating a vibration in the device on command, such as a mechanical vibrator or a vibrating alert motor. The aforementioned devices are only examples, and other devices may be added or substituted.

Computing device 600 may also contain a network connection device 615 that may allow device 600 to communicate with other computing devices 618, such as over a network in a distributed computing environment, for example, an intranet or the Internet. Device 615 may be a wired or wireless network interface controller, a network interface card, a network interface device, a network adapter, or a LAN adapter. Device 615 allows for a communication connection 616 for communicating with other computing devices 618. Communication connection 616 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both computer storage media and communication media.

As stated above, a number of program modules and data files may be stored in system memory 604, including operating system 605. While executing on processing unit 602, programming modules 606 (e.g., program module 607) may perform processes including, for example, one or more of the stages of the process 300 as described above. The aforementioned processes are examples, and processing unit 602 may perform other processes. Other programming modules that may be used in accordance with embodiments herein may include electronic mail and contacts applications, word processing applications, spreadsheet applications, database applications, slide presentation applications, drawing or computer-aided application programs, etc.

Generally, consistent with embodiments herein, program modules may include routines, programs, components, data structures, and other types of structures that may perform particular tasks or that may implement particular abstract data types. Moreover, embodiments herein may be practiced with other computer system configurations, including hand-held devices, multiprocessor systems, microprocessor-based or programmable consumer electronics, minicomputers, mainframe computers, and the like. Embodiments herein may also be practiced in distributed computing environments where tasks are performed by remote processing devices that are linked through a communications network. In a distributed computing environment, program modules may be located in both local and remote memory storage devices.

Furthermore, embodiments herein may be practiced in an electrical circuit comprising discrete electronic elements, packaged or integrated electronic chips containing logic gates, a circuit utilizing a microprocessor, or on a single chip (such as a System on Chip) containing electronic elements or microprocessors. Embodiments herein may also be practiced using other technologies capable of performing logical operations such as, for example, AND, OR, and NOT, including but not limited to mechanical, optical, fluidic, and quantum technologies. In addition, embodiments herein may be practiced within a general-purpose computer or in any other circuits or systems.

Embodiments herein, for example, are described above with reference to block diagrams and/or operational illustrations of methods, systems, and computer program products according to said embodiments. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments have been described, other embodiments may exist. Furthermore, although embodiments herein have been described as being associated with data stored in memory and other storage mediums, data can also be stored on or read from other types of computer-readable media, such as secondary storage devices, like hard disks, floppy disks, or a CD-ROM, or other forms of RAM or ROM. Further, the disclosed methods' stages may be modified in any manner, including by reordering stages and/or inserting or deleting stages, without departing from the claimed subject matter.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A system for ensuring quality of buried asset detection data over a communications network, the system comprising:
a server communicably coupled with a communications network, the server including a processor configured for:
a) receiving buried asset detection data from an electromagnetic locator device (ELD) over the communications network;
b) evaluating a quality of the buried asset detection data;
c) responsive to determining that the quality of the buried asset detection data meets a predefined threshold, transmitting an approval signal over the communications network to the ELD, wherein the approval signal indicates the quality of the buried asset detection data meets the predefined threshold, and opening access for receiving additional buried asset detection data from the ELD;
d) responsive to determining that the quality of the buried asset detection data does not meet the predefined threshold, transmitting a rejection signal over the communications network to the ELD, wherein the rejection signal indicates the quality of the buried asset detection data does not meet the predefined threshold, and closing access for receiving buried asset detection data from the ELD for other sites;
the ELD communicably coupled with the communications network, the ELD including a processor configured for:
a) collecting a first set of buried asset detection data at a site;
b) transmitting the first set of buried asset detection data to the server over the communications network;
c) wherein if the first buried asset detection data meets the predefined threshold, receiving from the server, over the communications network, the approval signal; and
d) wherein if the first buried asset detection data does not the predefined threshold, receiving from the server, over the communications network, the rejection signal.

2. The system of claim 1, wherein the step of receiving buried asset detection data further comprises receiving buried asset detection data comprising at least depth data, depth measurement data, electromagnetic signal measurement data, direction data and orientation data.

3. The system of claim 2, wherein the step of receiving buried asset detection data further comprises receiving buried asset detection data further comprising at least motion data of the ELD, electromagnetic data from the ELD, a mode of the ELD, and position data of the ELD.

4. The system of claim 3, wherein the step of evaluating a quality of the buried asset detection data further comprises:
reading the buried asset detection data;
calculating a plurality of component values of a performance record based on the buried asset detection data;
accessing a lookup table, and reading a performance measurement that corresponds with each one of said plurality of component values of the performance record, so as to read a plurality of performance measurements; and
comparing the plurality of performance measurements to a set of predefined thresholds to determine if said plurality of performance measurements meet or exceed the set of predefined thresholds.

5. The system of claim 4, wherein the step of receiving from the server the rejection signal further comprises disabling functionality for transmitting buried asset detection data to the server over the communications network.

6. The system of claim 1, further comprising:
responsive to receiving from the server the rejection signal, displaying a prompt to the user indicating that the user should repeat a buried asset detection procedure.

7. The system of claim 6, further comprising:
the ELD collecting a second set of buried asset detection data at the site; and
the ELD transmitting the second set of buried asset detection data to the server over the communications network.

8. The system of claim 7, further comprising:
the server receiving the second set of buried asset detection data from the ELD over the communications network;
the server evaluating a quality of the second set of buried asset detection data;
responsive to determining that the quality of the second set of buried asset detection data meets the predefined threshold, the server transmitting the approval signal over the communications network to the ELD, wherein the approval signal indicates the quality of the second set of buried asset detection data meets the predefined threshold, and opening access for receiving additional buried asset detection data from the ELD.

9. The system of claim 8, further comprising:
the ELD receiving from the server, over the communications network, the approval signal.

10. The system of claim 8, further comprising:
responsive to receiving from the server the approval signal, displaying a message to the user indicating that the second set of buried asset detection data meets the predefined threshold.
a database communicably coupled with the server, the database configured for storing the buried asset detection data and the quality of the buried asset detection data;

11. A system for ensuring quality of buried asset detection data over a communications network, the system comprising:
a server communicably coupled with a communications network, the server including a processor configured for:
a) receiving buried asset detection data from an electromagnetic locator device (ELD) over the communications network;
b) evaluating a quality of the buried asset detection data;
c) responsive to determining that the quality of the buried asset detection data meets a predefined threshold, transmitting an approval signal over the communications network to the ELD, wherein the approval signal indicates the quality of the buried asset detection data meets the predefined threshold, and opening access for receiving additional buried asset detection data from the ELD;
d) responsive to determining that the quality of the buried asset detection data does not meet the predefined threshold, transmitting a rejection signal over the communications network to the ELD, wherein the rejection signal indicates the quality of the buried asset detection data does not meet the predefined threshold, and closing access for receiving buried asset detection data from the ELD for other sites;
the ELD communicably coupled with the communications network, the ELD including a processor configured for:
a) collecting a first set of buried asset detection data at a site;
b) transmitting the first set of buried asset detection data to the server over the communications network;
c) wherein if the first buried asset detection data meets the predefined threshold, receiving from the server, over the communications network, the approval signal; and
e) wherein if the first buried asset detection data does not the predefined threshold, receiving from the server, over the communications network, the rejection signal.

12. The system of claim 11, wherein the step of receiving buried asset detection data further comprises receiving buried asset detection data comprising at least depth data, depth measurement data, electromagnetic signal measurement data, direction data and orientation data.

13. The system of claim 12, wherein the step of receiving buried asset detection data further comprises receiving buried asset detection data further comprising at least motion data of the ELD, electromagnetic data from the ELD, a mode of the ELD, and position data of the ELD.

14. The system of claim 13, wherein the step of evaluating a quality of the buried asset detection data further comprises:
reading the buried asset detection data;
calculating a plurality of component values of a performance record based on the buried asset detection data;
accessing a lookup table, and reading a performance measurement that corresponds with each one of said plurality of component values of the performance record, so as to read a plurality of performance measurements; and
comparing the plurality of performance measurements to a set of predefined thresholds to determine if said plurality of performance measurements meet or exceed the set of predefined thresholds.

15. The system of claim 14, wherein the step of receiving from the server the rejection signal further comprises disabling functionality for transmitting buried asset detection data to the server over the communications network.

16. The system of claim 11, further comprising:
responsive to receiving from the server the rejection signal, displaying a prompt to the user indicating that the user should repeat a buried asset detection procedure.

17. The system of claim 16, further comprising:
the ELD collecting a second set of buried asset detection data at the site; and
the ELD transmitting the second set of buried asset detection data to the server over the communications network.

18. The system of claim 17, further comprising:
the server receiving the second set of buried asset detection data from the ELD over the communications network;
the server evaluating a quality of the second set of buried asset detection data;
responsive to determining that the quality of the second set of buried asset detection data meets the predefined threshold, the server transmitting the approval signal over the communications network to the ELD, wherein the approval signal indicates the quality of the second set of buried asset detection data meets the predefined threshold, and opening access for receiving additional buried asset detection data from the ELD.

19. The system of claim 18, further comprising:
the ELD receiving from the server, over the communications network, the approval signal.

20. The system of claim 18, further comprising:
responsive to receiving from the server the approval signal, displaying a message to the user indicating that the second set of buried asset detection data meets the predefined threshold.
